(19) United States
(12) Patent Application Publication
(10) Pub. No.: US 2007/0234307 A1
(43) Pub. Date: Oct. 4, 2007

(54) Methods and apparatus to inline conditional software instrumentation

(76) Inventors: Chi-Keung Luk, Ashland, MA (US); Robert S. Cohn, Salem, NH (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/369,051

(22) Filed: Mar. 6, 2006

(51) Int. Cl. G06F 9/44

(52) U.S. Cl. 717/130

(57) ABSTRACT

Methods and apparatus to inline conditional software instrumentation are disclosed. An example method comprises splitting a software instrumentation conditional analysis procedure for an application segment into an unconditional portion and a conditional portion, and inlining the unconditional portion.

### FIELD OF THE DISCLOSURE

This disclosure relates generally to software instrumentation and, more particularly, to methods and apparatus to inline conditional software instrumentation.

### BACKGROUND

Instrumentation of a software application is a powerful method to understand the behavior of the software application by inserting extra analysis code into the application. Software instrumentation tools allow a programmer to write the analysis code in, for example, the form of a procedure and to define via, for example, an instrumentation routine where in the software application the analysis procedure is to be called. An example instrumentation routine causes a memory trace procedure to be called (i.e., executed) whenever memory is accessed and/or written by the software application.

### BRIEF DESCRIPTION OF THE DRAWINGS

FIG. 1 is a schematic illustration of an example software instrumentation tool.

FIG. 2 is an example manner of implementing the example just-in-time (JIT) compiler of FIG. 1.

FIG. 3 illustrates example conditional software instrumentation source code.

FIG. 4 illustrates an example modification of the example conditional software instrumentation code of FIG. 3 to facilitate inlining of conditional instrumentation.

FIG. 5 is a flowchart representative of example machine readable instructions which may be executed to modify and/or inline conditional software instrumentation.

FIG. 6 is a chart illustrating example performance improvements resulting from application of the example machine readable instructions of FIG. 5.

FIG. 7 is a schematic illustration of an example processor platform that may be used and/or programmed to execute the example machine readable instructions illustrated in FIG. 5 to implement the example software instrumentation tool of FIG. 1.

### DETAILED DESCRIPTION

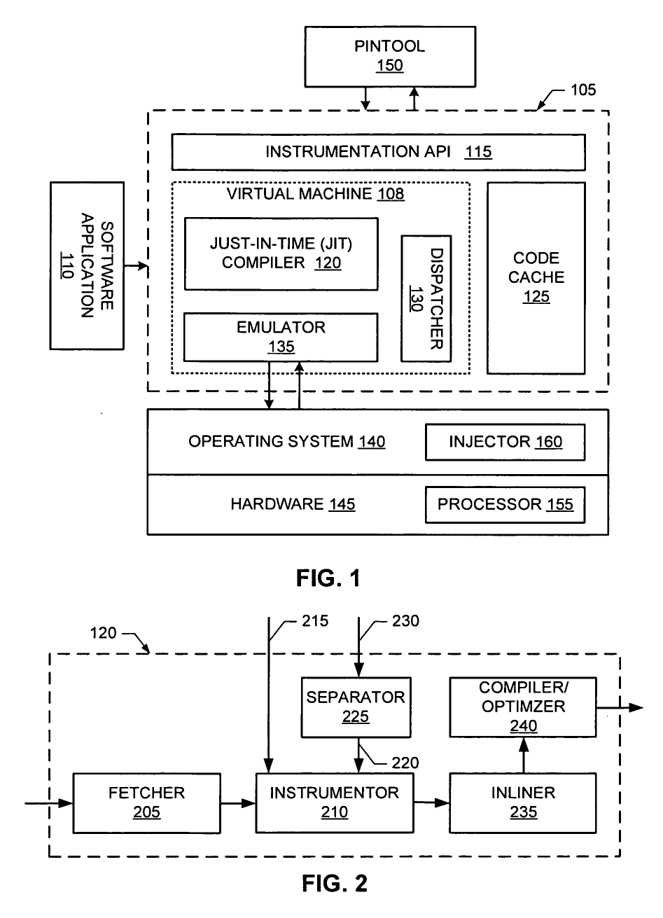

FIG. 1 is a schematic illustration of an example software instrumentation tool (a.k.a. Pin) 105 from Intel® that supports Linux binary executables for Intel Xscale®, IA-32, IA-32E (64 bit×86) and Itanium® processors. Although an example software instrumentation tool 105 has been illustrated in FIG. 1, software instrumentation tools may be implemented using any of a variety of other and/or additional modules, hardware, software, firmware, devices, components and/or circuits. Further, the modules, hardware, software, firmware, devices, components and/or circuits illustrated in FIG. 1 may be combined, re-arranged, eliminated and/or implemented in any of a variety of ways. For simplicity and ease of understanding, the following disclosure references the example software instrumentation tool 105 of FIG. 1, but any other software instrumentation tool such as, for example, the analysis tool for object modification (ATOM) toolkit, DynamoRIO, etc. could be modified and/or adapted to implement any of the methods of inlining conditional instrumentation disclosed herein. Additionally, the methods of inlining conditional instrumentation disclosed herein may be applied to other operating systems such as, for example, Microsoft® Windows®, MacOS®, UNIX®, Berkeley Software Distribution (BSD) UNIX®, etc.

The example software implementation tool 105 dynamically instruments a software application 110 while the software application 110 is running and/or is being executed by the example software implementation tool 105. In the illustrated example of FIG. 1, the example software instrumentation tool 105 instruments, at run-time, the software application 110 by adding (e.g., inserting) analysis code (e.g., an analysis procedure) into the software application 110. The example software application 110 of FIG. 1 is a native binary executable 110 stored in any variety of code store such as, for example, a computer file, a memory device and/or circuitry, etc. Alternatively, the software application 110 may be bytecode, source code, any variety of intermediate representation, etc.

The example software instrumentation tool 105 of FIG. 1 can attach and detach from the example software application 110 like a debugger. In particular, the example software instrumentation tool 105 can attach to an already executing process (e.g., the software application 110), instrument the process, collect instrumentation data, and subsequently detach from the process. In the example of FIG. 1, the executing software application 110 only incurs instrumentation overhead during the period of time that the example software instrumentation tool 105 is attached to the software application 110. Further, the example software instrumentation tool 105 of FIG. 1 automatically saves and subsequently restores registers that are overwritten by inserted analysis procedures so that the software application 110 executing as an instrumented process may continue to operate correctly.

To allow a programmer to observe the state of an instrumented process such as, for example, the contents of registers, memory, control flow, etc., the example software instrumentation tool 105 of FIG. 1 includes any variety of instrumentation application programming interface (API) 115. The example instrumentation API 115 of FIG. 1 allows the programmer to add, for instance, analysis procedures to the software application 110 and to specify where calls to the analysis procedures are placed (i.e., inserted) via, for example, instrumentation routines. The example software instrumentation tool 105 and/or the example instrumentation API 115 allow the programmer to specify inspection (i.e., instrumentation) on an instruction-by-instruction basis or of whole traces, procedures and/or images. The example instrumentation API 115 of FIG. 1 abstracts away the underlying instruction set idiosyncrasies and allows context information such as register contents to be passed to the injected analysis procedures as parameters, and may also provide limited access to symbol and/or debug information.

To perform instrumentation of the software application 110, the example software instrumentation tool 105 includes a just-in-time (JIT) compiler 120. To instrument a portion of a process that is executing the example software application 110, the example JIT compiler 120 of FIG. 1 intercepts the first instruction of the portion of the process, possibly instruments the portion, generates (e.g., compiles) new binary code for the portion, and performs a control change so that the generated binary code is executed in place of the original process. In the illustrated example, the generated binary code is similar to the replaced code, except for any instrumentation code inserted in the original software application 110.

When execution of the generated binary code is complete, the example software instrumentation tool 105 regains control of the process. After regaining control, the JIT compiler 120 generates more binary code for another portion of the process and execution continues. Each time the JIT compiler 120 fetches additional code for the process, the JIT compiler 120 has the opportunity to instrument the code before it is translated (i.e., compiled) for execution. However, instrumentation may or may not be inserted into the intercepted code, depending upon the particular circumstances.

To store the generated binary code, the example software instrumentation tool 105 of FIG. 1 includes any variety of code cache 125. Using any of a variety of methods and/or techniques, the example code cache 125 of FIG. 1 is used to improve execution performance of an instrumented process if and/or when a portion of the instrumented process is re-executed by eliminating the need to re-insert instrumentation code and/or to recompile code sections.

To control the flow of instructions and/or execution, the example software instrumentation tool 105 of FIG. 1 includes any variety of dispatcher 130. Among other things, the example dispatcher 130 of FIG. 1 coordinates the execution flow of instructions. In particular, the example dispatcher 130 of FIG. 1 keeps track of which instructions have generated binary code already stored in the code cache 125 and which instructions need to be fetched, instrumented, inlined and/or optimized by the JIT compiler 120.

To interpret instructions that cannot be directly executed by the example software instrumentation tool 105, the example software instrumentation tool 105 of FIG. 1 includes an emulator 135. The example emulator 135 of FIG. 1 is used to interpret system calls to an operating system (OS) 140 that is executing on a hardware platform 145. In the example software instrumentation tool 105 of FIG. 1, system calls to the OS 140 require special handling since the example software instrumentation tool 105 executes (i.e., sits) above the OS 140 and, thus, can only capture (i.e., instrument) user-level code (i.e., the code contained in the software application 110).

In the illustrated example of FIG. 1, the example JIT compiler 120, the dispatcher 130 and/or the emulator 135 are implemented in a virtual machine (VM) executing on the OS 140 and/or the hardware 145. Further, the OS 140 is a Linux-based operating system and the hardware 145 includes, among other things, at least one processor 155 upon which the OS 140, the software application 110, the example software instrumentation tool 105 and/or a binary program 150 are executed. While in the illustrated example, the processor 155 is an Intel Xscale®, IA-32, IA-32E (64 bit×86) or Itanium® processor, any variety and/or number of processors could be used to implement the methods and apparatus described herein. Additionally, the OS 140 could be any other operating system such as, for example, Microsoft® Windows®, MacOS®, UNIX®, BSD UNIX®, etc.

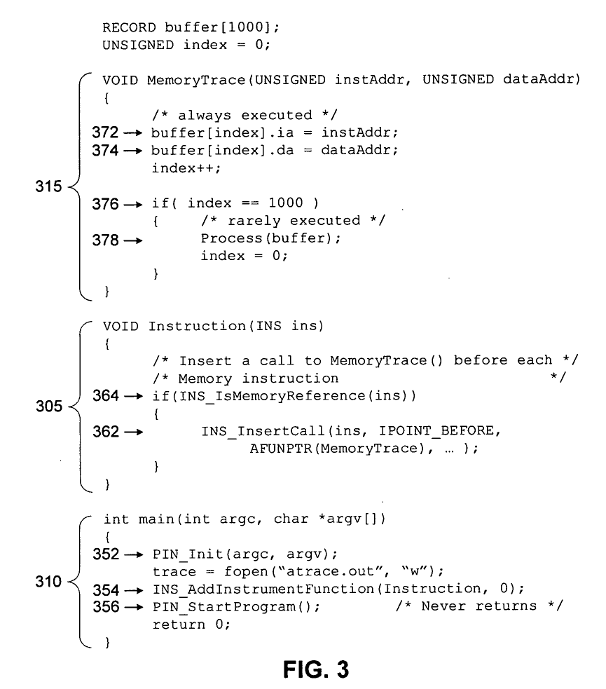

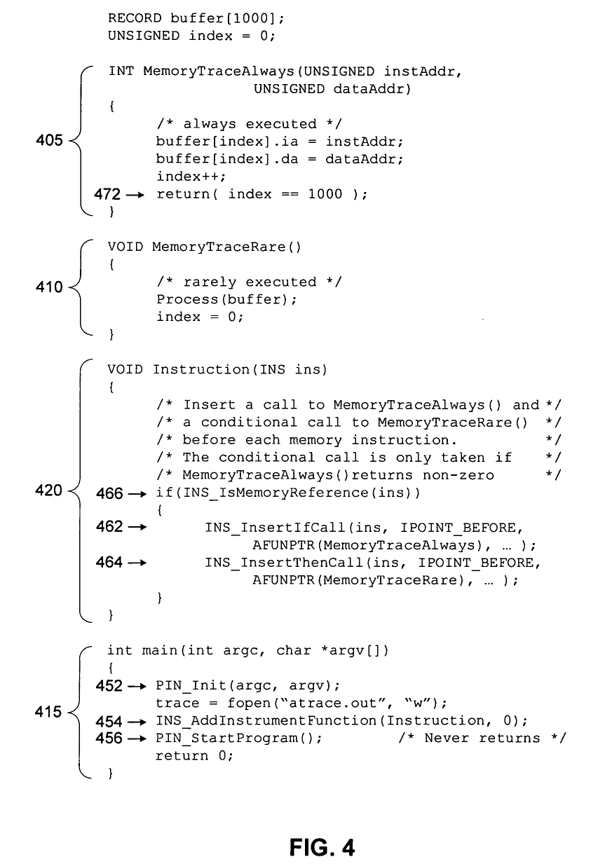

To provide the example software instrumentation tool 105 with the instrumentation routines and the analysis procedures, the illustrated example of FIG. 1 includes the binary program 150 (a.k.a., pintool 150). The example pintool 150 of FIG. 1 has access to or is otherwise linked with a library that allows the example pintool 150 to communicate with the example software instrumentation tool 105 via the instrumentation API 115. The binary program 150 is created by writing and/or generating and then compiling a source code file. Example source code is described below in connection with FIGS. 3 and 4.

As illustrated in FIG. 1, there are three binary programs present in the address space of the processor 155 when an instrumented program (e.g., the software application 110) is running, namely, (1) the software application 110, (2) the example software instrumentation tool 105 and (3) the pintool 150. While these programs share a common address space, in the example of FIG. 1, they do not share any libraries to avoid unwanted interactions such as, for example, re-entrancy problems, etc.

To instrument a program (e.g., the software application 110), an injector 160 provided by, for example, the OS 140 loads the example software instrumentation tool 105 into the address space of the software application 110. In the example of FIG. 1, the injector 160 uses the UNIX Ptrace API to obtain control of the software application 110 and to capture the context of the processor 155. Having captured the processor context, the injector 160 loads the example software instrumentation tool 105 of FIG. 1 into the address space and then starts the execution of the example software instrumentation tool 105. After initializing itself, the example software instrumentation tool 105 loads the pintool 150 into the address space and starts it running. The pintool 150 subsequently initializes itself and then requests that the example software instrumentation tool 105 start execution of the software application 110. As described above, the example software instrumentation tool 105 starts fetching, instrumenting, inlining, compiling, optimizing and executing and/or emulating the software application 110.

FIG. 2 illustrates an example manner of implementing the example JIT compiler 120 of FIG. 1. To fetch a portion of the software application 110, the example JIT compiler 120 of FIG. 2 includes a fetcher 205. The example fetcher 205 of FIG. 2 fetches instructions one trace at a time. In the example of FIG. 2, a trace is a straight-line sequence of instructions which terminates at one of the following conditions: (a) an unconditional control transfer (e.g., branch, call, return), (b) after a pre-defined number of conditional control transfers, and/or (c) after a pre-defined number of instructions have been fetched in the trace.

To instrument a fetched set of instructions, the example JIT compiler 120 includes an instrumentor 210. Using instrumentation routines 215 provided by the pintool 150, the example instrumentor 210 of FIG. 2 identifies the locations in the fetched instructions where analysis procedures 220 are to be inserted.

To provide the analysis procedures 220 to the example instrumentor 210, the example JIT compiler 120 includes a separator 225. In the example of FIG. 2, the example separator 225 splits (i.e., separates) conditional analysis procedures 230 provided by the pintool 150 into an unconditional portion and a conditional portion. The unconditional and conditional portions are provided to the instrumentor 210 which then inserts them into the fetched instructions at the locations identified by the instrumentation routines 215. Unconditional analysis procedures 230 may be provided directly to the instrumentor 210 or, as illustrated in FIG. 2, may be passed through the separator 225.

Additionally or alternatively, as discussed below in connection with FIG. 4, if a conditional analysis procedure is written and/or provided by the pintool 150 as an unconditional portion and a conditional portion, the example separator 225 of FIG. 2 does not need to split the conditional analysis procedure. In the illustrated examples of FIGS. 1 and 2, the pintool 150 may provide some conditional analysis procedures split and some unsplit depending upon how a programmer writes the source code for the instrumentation routines and/or the analysis procedures. Thus, the example JIT compiler 120 of FIG. 2 may receive both split and unsplit conditional analysis procedures. In the example of FIG. 2, the example separator 225 may be configured to automatically split conditional analysis procedures or may be disabled and/or bypassed by the pintool 150 via the API 115.

To inline analysis routines that may be inlined, the example JIT compiler 120 of FIG. 2 includes an inliner 235. When the example inliner 235 encounters any unconditional analysis routine or any unconditional portion of a conditional analysis routine, the example inliner 235 of FIG. 2 using any variety of methods inlines the encountered routine or portion. For example, rather than inserting a function call, instructions to save registers, etc. to the unconditional analysis routine or the unconditional portion of a conditional analysis routine, the example inliner 235 of FIG. 2 inserts the instructions of the unconditional analysis routine or the unconditional portion of a conditional analysis routine.

To compile and/or optimize the inlined and/or instrumented instructions, the example JIT compiler 120 of FIG. 2 includes any variety of compiler/optimizer 240. Using any variety of compilation and/or optimization techniques and/or methods, the example compiler/optimizer 240 compiles and/or optimizes the instrumented and/or inlined instructions. In the example of FIG. 2, the compilations and/or optimizations applied depend upon the type(s) of processor(s) 155 that are executing the example software instrumentation tool 105, the software application 110, the OS 140 and/or the pintool 150.

FIG. 3 illustrates a portion of example conditional software instrumentation source code that may be compiled to implement all or a portion of an example pintool 150. To initialize the example software instrumentation tool 105 (line 352), register (i.e., provide) an instrumentation routine 305 (line 354), and start execution of the instrumented software application 110 (line 356), the example source code includes a main procedure 310.

In the examples of FIGS. 1-3, the example instrumentor 210 of FIG. 2 uses the example instrumentation routine 305 of FIG. 3 while inserting analysis procedures to determine where to insert analysis procedures. The example instrumentation routine 305 of FIG. 3 instructs the example instrumentor 210 to insert an analysis procedure MemoryTrace 315 (line 362) before each memory reference (e.g., read, write, etc.) (line 364).

For each memory reference instruction, the example analysis procedure 315 of FIG. 3 records the instruction address (line 372) and the address of the data referenced (line 374) into a buffer. Occasionally when the buffer is full (line 376), the example analysis procedure 315 processes the buffer (line 378). Since, the example analysis procedure 315 of FIG. 3 has a possible control-change (line 376), the example analysis procedure 315 cannot be inlined by the example inliner 235 of FIG. 2.

FIG. 4 illustrates an example modification of the example conditional software instrumentation source code of FIG. 3 that facilitates inlining at least a portion of the conditional analysis procedure 315 illustrated in FIG. 3. In the example of FIG. 4, a programmer writing, generating and/or developing the example source code of FIG. 4 modifies the example conditional analysis procedure 315 of FIG. 3 into an unconditional portion 410 and a conditional portion 415. Additionally or alternatively, as described above in connection with FIG. 2, the example separator 225 can split the example conditional analysis routine 315 into the two portions 410 and 415.

The example main procedure 415 of FIG. 4 initializes the example software instrumentation tool 105 (line 452), registers (i.e., provides) the instrumentation routine 420 (line 454), and starts execution of the instrumented software application 110 (line 456). The example main procedure 415 of FIG. 4 is identical to the example main procedure 310 of FIG. 3. However, since the example source code of FIGS. 3 and 4 define different instrumentation routines and analysis procedures, the instrumentation instructions inserted by the example instrumentor 210 of FIG. 2 are different for the two examples and, thus, in the example of FIG. 4, the example inliner 235 is able to inline the unconditional portion 405 of the analysis procedure.

The example instrumentor 210 of FIG. 2 calls the example instrumentation routine 420 of FIG. 4 when the example instrumentor 210 is instrumenting the software application 110. The example instrumentation routine 420 of FIG. 4 instructs the example instrumentor 210 to insert an unconditional portion 405 of the example analysis procedure MemoryTrace 315 of FIG. 3 (line 462) and a conditional portion 410 of the example procedure 315 (line 464) before each memory reference (e.g., read, write, etc.) (line 466).

In the example of FIG. 4, the unconditional portion 405 contains the portion of the example analysis procedure MemoryTrace 315 of FIG. 3 that is performed for each memory reference. The example conditional portion 410 of FIG. 4 contains the portion of the example analysis procedure MemoryTrace 315 of FIG. 3 that is performed when the buffer needs to be processed. The example unconditional portion 405 of FIG. 4 also evaluates the original if-then condition and returns the result of the evaluation as a return value (line 472). In the illustrated example, the example conditional portion 410 is only invoked if the return value from the unconditional portion 405 is TRUE (i.e., non-zero) (line 464).

As illustrated in FIG. 4, the modifications of the example conditional analysis procedure 315 of FIG. 3 can be performed by a programmer via additional instrumentation API calls (e.g., example lines 462 and 464 of FIG. 4). Additionally or alternatively, the modifications may be performed by the dynamic compiler used to compile the example source code of FIG. 3 and/or by the example separator 225 of FIG. 2.

In the examples of FIGS. 2 and 4, the inliner 235 inlines the example unconditional portion 405 of FIG. 4 whenever possible. Further, the example compiler/optimizer 240 of FIG. 2 generates code to pass the result returned from the example unconditional portion 405 to generated code that implements a “then” analysis procedure. If the return value is TRUE, the “then” analysis procedure invokes the example conditional portion 410 of FIG. 4.

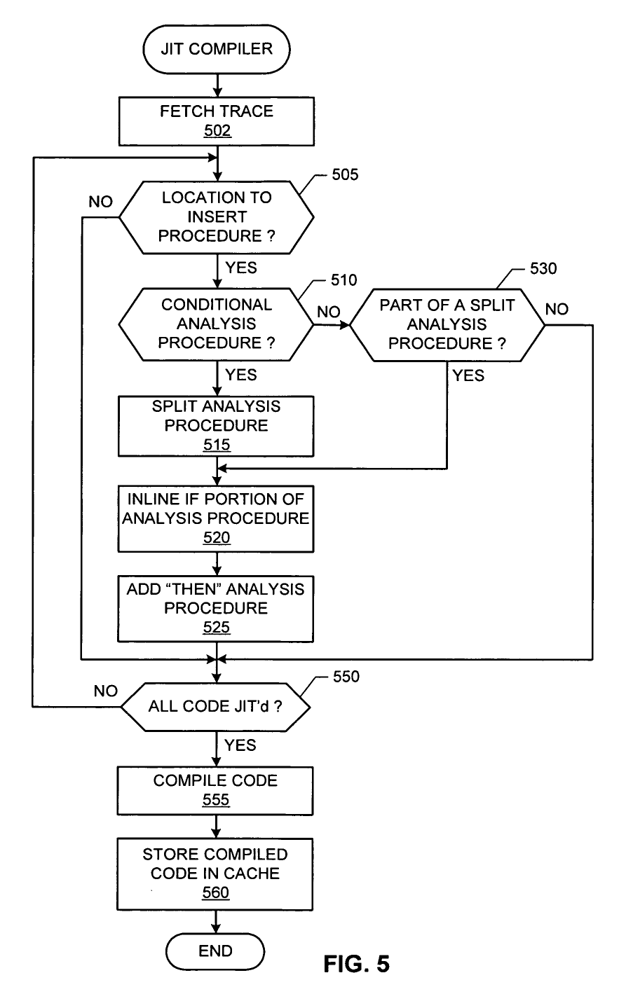

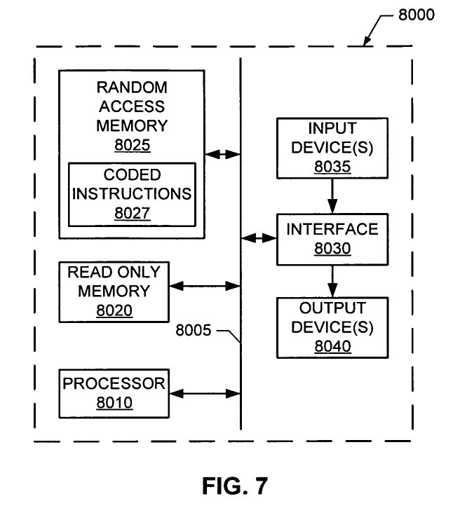

FIG. 5 illustrates a flowchart representative of example machine readable instructions that may be executed to implement the example JIT compiler 120 of FIGS. 1 and/or 2. The example machine readable instructions of FIG. 5 may be executed by a processor, a controller and/or any other suitable processing device. For example, the example machine readable instructions of FIG. 5 may be embodied in coded instructions stored on a tangible medium such as a flash memory, or random access memory (RAM) associated with a processor (e.g., the example processor 155 of FIG. 1 and/or the processor 8010 shown in the example processor platform 8000 and discussed below in conjunction with FIG. 7). Alternatively, some or all of the example flowchart of FIG. 5 may be implemented using an application specific integrated circuit (ASIC), a programmable logic device (PLD), a field programmable logic device (FPLD), discrete logic, hardware, firmware, etc. Also, some or all of the example flowchart of FIG. 5 may be implemented manually or as combinations of any of the foregoing techniques, for example, a combination of firmware, software and/or hardware. Further, although the example machine readable instructions of FIG. 5 are described with reference to the flowchart of FIG. 5, persons of ordinary skill in the art will readily appreciate that many other methods of implementing example JIT compiler 120 of FIGS. 1 and/or 2 may be employed. For example, the order of execution of the blocks may be changed, and/or some of the blocks described may be changed, eliminated, sub-divided, or combined. Additionally, persons of ordinary skill in the art will appreciate that the example machine readable instructions of FIG. 5 be carried out sequentially and/or carried out in parallel by, for example, separate processing threads, processors, devices, circuits, etc.

The example machine readable instructions of FIG. 5 begin with the JIT compiler 120 fetching a trace of instructions (block 502). For each of the fetched instructions, the JIT compiler 120 determines if an analysis procedure is to be inserted based on one or more instrumentation routines provided by the pintool 150 (block 505). If no analysis procedure is to be inserted for this instruction (block 505), control proceeds to block 550.

If an analysis procedure is to be inserted (block 505), the JIT compiler 120 determines if the analysis procedure to be inserted is a conditional analysis procedure (block 510). If the analysis procedure to be inserted is conditional (block 510), the JIT compiler 120 separates (i.e., splits) the conditional analysis routine into an unconditional portion and a conditional portion (block 515), inlines the unconditional portion (block 520) and inserts a “then” analysis procedure between the two portions (block 525).

Returning to block 510, and assuming an analysis procedure is to be inserted and if the procedure is not conditional, the JIT compiler 120 determines if the analysis procedure is part of a conditional analysis procedure that was split into an unconditional portion and a conditional portion by, for example, a programmer as illustrated in FIG. 4 (block 530). If the analysis procedure is not part of a split procedure (block 530), control proceeds to block 550. If the analysis procedure is part of a split procedure (block 530), control proceeds to block 520.

At block 550 the JIT compiler 120 determines if all of the fetched instructions have been processed and/or instrumented. If all instructions have not been processed (block 550), control returns to block 505 to process the next instruction.

If all instructions have been processed (block 550), the JIT compiler 120 compiles and/or optimized the processed and/or instrumented instructions (block 555) and the compiled and/or optimized instrumented and/or inlined instructions are stored in the code cache (block 560). The JIT compiler 120 then ends the example machine readable instructions of FIG. 5.

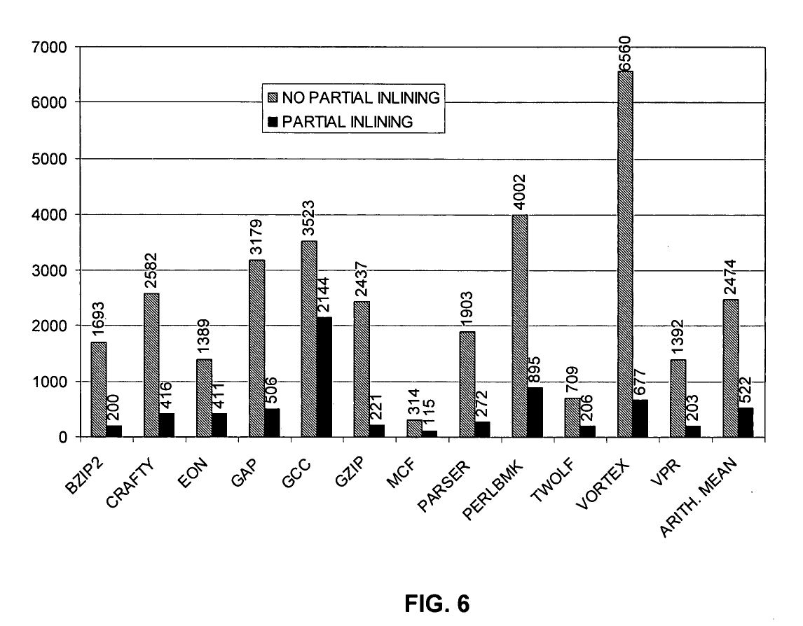

FIG. 6 illustrates example performance gains achieved by separating conditional analysis procedures into an unconditional portion and a conditional portion and then inlining the unconditional portion. The performance illustrated in FIG. 6 is relative to un-instrumented execution. That is, a normalized execution time of 200% indicates a two-fold (i.e., 2×) slowdown in execution due to instrumentation of the software application 110

A variety of SPECint applications 110 were instrumented and benchmarked using the example methodology described above. The results are illustrated in FIG. 6. FIG. 6 shows performance results for the applications without inlining applied (i.e., applications were instrumented with the example source code of FIG. 3), and the performance results for the applications having partial inlining applied (i.e., inlining of the unconditional portion 405 using the example source code of FIG. 4). As illustrated in FIG. 6, instrumentation without inlining results in an average slowdown of 24.7×, while partial inlining results in an average slowdown of only 5.2× which is approximately a 5× improvement in execution speed.

FIG. 7 is a schematic diagram of an example processor platform 8000 that may be used and/or programmed to implement the example JIT compiler 120 and/or more generally the hardware 145. For example, the processor platform 8000 can be implemented by one or more general purpose microprocessors, microcontrollers, etc.

The processor platform 8000 of the example of FIG. 7 includes a general purpose programmable processor 8010 corresponding to, for example, the processor 155. The processor 8010 executes coded instructions 8027 present in main memory of the processor 8010 (e.g., within a RAM 8025). The processor 8010 may be any type of processing unit, such as a microprocessor from the Intel® families of microprocessors. The processor 8010 may execute, among other things, the example machine readable instructions of FIG. 5 to implement the example JIT compiler 120 of FIGS. 1 and/or 2.

The processor 8010 is in communication with the main memory (including a read only memory (ROM) 8020 and the RAM 8025) via a bus 8005. The RAM 8025 may be implemented by dynamic random access memory (DRAM), Synchronous DRAM (SDRAM), and/or any other type of RAM device, and ROM may be implemented by flash memory and/or any other desired type of memory device. Access to the memory 8020 and 8025 is typically controlled by a memory controller (not shown) in a conventional manner.

The processor platform 8000 also includes a conventional interface circuit 8030. The interface circuit 8030 may be implemented by any type of well-known interface standard, such as an external memory interface, serial port, general purpose input/output, etc.

One or more input devices 8035 and one or more output devices 8040 are connected to the interface circuit 8030. For example, the input devices 8035 may be used to implement interfaces between the JIT compiler 120 and the software application 110.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method comprising:
splitting a software instrumentation conditional analysis procedure for an application segment into an unconditional portion and a conditional portion; and
inlining the unconditional portion.

2. A method as defined in claim 1, further comprising inserting at least one of the software instrumentation conditional analysis procedure, the unconditional portion or the conditional portion into the application segment.

3. A method as defined in claim 2, further comprising executing the application segment.

4. A method as defined in claim 2, further comprising storing the application segment with the at least one of the software instrumentation analysis procedure, the unconditional portion or the conditional portion in a code cache, wherein the application segment is executed from the code cache.

5. A method as defined in claim 1, further comprising optimizing a combined segment formed from the application segment, the inlined unconditional portion and the conditional portion.

6. A method as defined in claim 1, further comprising fetching the application segment, wherein at least one of the splitting or the inlining is performed when the application segment is fetched.

7. A method as defined in claim 1, wherein the application segment is a native executable segment.

8. An article of manufacture storing machine readable instructions which, when executed, cause a machine to:
split a software instrumentation conditional analysis procedure for an application segment into an unconditional portion and a conditional portion; and
inline the unconditional portion.

9. An article of manufacture as defined in claim 8, wherein the machine readable instructions, when executed, cause the machine to insert at least one of the software instrumentation conditional analysis procedure, the unconditional portion or the conditional portion into the application segment.

10. An article of manufacture as defined in claim 9, wherein the machine readable instructions, when executed, cause the machine to execute the application segment.

11. An article of manufacture as defined in claim 9, wherein the machine readable instructions, when executed, cause the machine to, further comprising storing the application segment with the at least one of the software instrumentation analysis procedure, the unconditional portion or the conditional portion in a code cache, wherein the application segment is executed from the code cache.

12. An article of manufacture as defined in claim 8, wherein the machine readable instructions, when executed, cause the machine to optimize a combined segment formed from the application segment, the inlined unconditional portion and the conditional portion.

13. An article of manufacture as defined in claim 8, wherein the machine readable instructions, when executed, cause the machine to fetch the application segment, wherein at least one of the splitting or the inlining is performed when the application segment is fetched.

14. A software instrumentation apparatus comprising:
an instrumentor to modify a portion of a software application by inserting an instrumentation procedure into the software application;
a separator to split the instrumentation procedure to form an unconditional portion; and
an inliner to inline the unconditional part.

15. A software instrumentation apparatus as defined in claim 14, further comprising a fetcher to fetch the portion of the software application.

16. A software instrumentation apparatus as defined in claim 14, further comprising an optimizer to optimize the portion of the modified software application.

17. A software instrumentation apparatus as defined in claim 14, further comprising a code cache to store the portion of the modified software application.

18. A software instrumentation apparatus as defined in claim 17, further comprising a dispatcher to initiate execution of the portion of the modified software application from the code cache.

19. A software instrumentation apparatus as defined in claim 14, wherein the portion of the software application is a native executable.

20. A software instrumentation apparatus as defined in claim 14, wherein the software instrumentation apparatus comprises a virtual machine.

21. A software instrumentation apparatus as defined in claim 20, further comprising a just in time compiler to execute the virtual machine.

22. A software instrumentation apparatus as defined in claim 21, further comprising an emulator to interpret system calls to an operating system.

23. A software instrumentation apparatus as defined in claim 21, further comprising a dispatcher to call previous compiled code from a code cache.
